(19) United States
(12) Patent Application Publication
(10) Pub. No.: US 2024/0419331 A1
(43) Pub. Date: Dec. 19, 2024

(54) SSD Content Preloading Via Broadcasting System

(71) Applicant: Western Digital Technologies, Inc., San Jose, CA (US)

(72) Inventors: Julian VLAIKO, Kfar Saba, IL (US); Judah Gamliel HAHN, Ofra (IL); Shay BENISTY, Beer Sheva (IL); Ariel NAVON, Revava (IL); Alexander BAZARSKY, Holon (IL); Aki BLEYER, Givatayim (IL)

(73) Assignee: Western Digital Technologies, Inc., San Jose, CA (US)

(21) Appl. No.: 18/218,874

(22) Filed: Jul. 6, 2023

Related U.S. Application Data
(60) Provisional application No. 63/521,307, filed on Jun. 15, 2023.

(51) Int. Cl. G06F 3/06

(52) U.S. Cl. CPC G06F 3/0613; G06F 3/0647; G06F 3/0679

(57) ABSTRACT

In a storage system having a plurality of solid state drives (SSDs), the performance of propagating data from a primary device to each secondary device may be improved using a dedicated high speed data channel in which data and commands associated with the data is sent from an upstream SSD to a downstream SSD. The data is also sent to the downstream SSD after a minimum amount of data has been programmed to the upstream SSD. The downstream SSD begins programming the data to its own memory device after receiving the data. The programming of data to each SSD of the storage system may be in parallel and at least partially concurrent with each other. Data, commands, and control messages may be sent an upstream SSD via a serial bus or a universal asynchronous receiver-transmitter channel, such that the downstream data paths and the upstream data paths are distinct.

### CROSS-REFERENCE TO RELATED APPLICATIONS

This application claims benefit of U.S. Provisional Patent Application Ser. No. 63/521,307, filed Jun. 15, 2023, which is herein incorporated by reference.

### BACKGROUND OF THE DISCLOSURE

### Field of the Disclosure

Embodiments of the present disclosure generally relate to a storage system having a plurality of data storage devices, such as a plurality of solid state drives (SSDs), in which data is broadcasted to the plurality of data storage devices from a primary device.

### Description of the Related Art

In communications, there are broadcasting based solutions that enable broadcasting data to a plurality of devices from a primary device. However, in storage systems utilizing data storage devices, the broadcasting based solutions may not be compatible with the data storage device standards, such as universal flash storage (UFS), peripheral component interconnect (PCI) express (PCIe), and the like, that are based on a handshake protocol between a host device and a data storage device. In the automotive industry, for example, preloaded content (images) or content being pushed out may be stored in a plurality of data storage devices, which may require a large volume of memory space. In order to store the preloaded content or the content being pushed out, the data must be burned onto each drive. Thus, in order to store the data to each of the plurality of storage devices, a large amount of time may be required. Furthermore, data is preloaded serially through a host on each data storage device during production. In other words, because data is stored on each data storage device sequentially, the amount of time to store the data in a plurality of data storage devices may cause a bottleneck on the overall performance of the storage system.

Therefore, there is a need in the art for an improved broadcasting based solution for storage systems having a plurality of data storage devices.

### SUMMARY OF THE DISCLOSURE

The present disclosure generally relates to a storage system having a plurality of data storage devices, such as a plurality of solid state drives (SSDs), in which data is broadcasted to the plurality of data storage devices from a primary device. In a storage system having a plurality of SSDs, the performance of propagating data from a primary device to each secondary device may be improved using a dedicated high speed data channel in which data and commands associated with the data is sent from an upstream SSD to a downstream SSD. The data is also sent to the downstream SSD after a minimum amount of data has been programmed to the upstream SSD. The downstream SSD begins programming the data to its own memory device after receiving the data. The programming of data to each SSD of the storage system may be in parallel and at least partially concurrent with each other. Data, commands, and control messages may be sent an upstream SSD via a serial bus or a universal asynchronous receiver-transmitter channel, such that the downstream data paths and the upstream data paths are distinct.

In one embodiment, a storage system includes a plurality of data storage devices. Each data storage device of the plurality of data storage devices is coupled to another data storage device of the plurality of data storage devices. Each data storage device includes an end point (EP) PCIe interface, a serial bus (SMB), and a high speed serial trace port (HSSTP) interface. The HSSTP interface includes a PCIe transmitter (TX), a universal asynchronous receiver-transmitter (UART) receiver (RX), and a UART TX. A first data storage device is configured to send data via the PCIe TX of the first data storage device to the EP PCIe interface of a second data storage device. The first data storage device is coupled to the second data storage device. The sending occurs after a predetermined amount of data that is less than all of the data has been programmed to the first data storage device.

In another embodiment, a storage system includes a first data storage device and a second data storage device coupled to the first data storage device. The first data storage device is configured to program data to a non-volatile memory (NVM) device of the first data storage device, generate a write command for the second data storage device to program the data to an NVM device of the second data storage device, and send the data to the second data storage device via a high speed data path coupling the first data storage device to the second data storage device after a predetermined amount of the data has been programmed to the NVM device of the first data storage device. The high speed data path is distinct from a low speed data path. The low speed data path has a data transfer speed less than the high speed data path. The high speed data path is utilized to transfer write data. The low speed data path is utilized to transfer read data. The second data storage device is configured to receive the data from the first data storage device and program the data to the NVM device of the second data storage device. Programming the data to the NVM device of the second data storage device occurs partially concurrently with programming the data to the NVM device of the first data storage device.

In another embodiment, a storage system includes a first data storage device, a second data storage device coupled to the first data storage device, means for transferring write data from the first data storage device to the second data storage device, and means for transferring read data and control data between the first data storage device and the second data storage device. The means for transferring write data is distinct from the means for transferring read data and control data.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic block diagram illustrating a storage system in which a plurality of SSDs are daisy-chained together, according to certain embodiments.

FIG. 3 is an exemplary graph illustrating a time to serially program data to a plurality of SSDs, according to certain embodiments.

FIG. 4 is an exemplary graph illustrating a time to program data in parallel to a plurality of SSDs, according to certain embodiments.

FIG. 5 is a flow diagram illustrating a method of broadcasting data to a plurality of SSDs in a storage system in which the plurality of SSDs are daisy-chained together, according to certain embodiments.

FIG. 6 is a flow diagram illustrating a method of reading data from a data storage device of a plurality of data storage devices in a storage system in which the plurality of data storage devices are daisy-chained together, according to certain embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates to a storage system having a plurality of data storage devices, such as a plurality of solid state drives (SSDs), in which data is broadcasted to the plurality of data storage devices from a primary device. In a storage system having a plurality of SSDs, the performance of propagating data from a primary device to each secondary device may be improved using a dedicated high speed data channel in which data and commands associated with the data is sent from an upstream SSD to a downstream SSD. The data is also sent to the downstream SSD after a minimum amount of data has been programmed to the upstream SSD. The downstream SSD begins programming the data to its own memory device after receiving the data. The programming of data to each SSD of the storage system may be in parallel and at least partially concurrent with each other. Data, commands, and control messages may be sent an upstream SSD via a serial bus or a universal asynchronous receiver-transmitter channel, such that the downstream data paths and the upstream data paths are distinct.

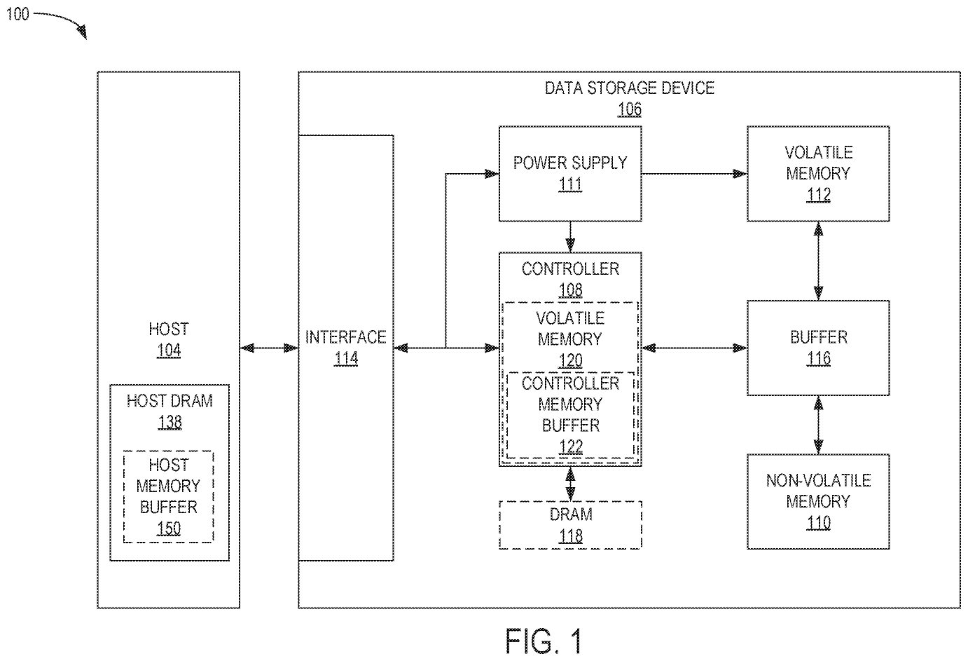

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host DRAM 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe ×1, ×4, ×8, ×16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. the PCIe TX interface 218 and the EP PCIe interface 212 may be operate under a different protocol other than PCIe.

Each PCIe TX interface 218 is coupled to an EP PCIe interface 212 of an adjacent downstream (i.e., from the host device 202 or the first SSD 1 210a) SSD. For example, the PCIe TX interface 218 of the first SSD 1 210a is coupled to the EP PCIe interface 212 of the second SSD 2 210b, where data may be transferred from the first SSD 2 210a to the second SSD 2 210b through a high speed bus 226 between the PCIe TX interface 218 of the first SSD 1 210a and the EP PCIe interface 212 of the second SSD 2 210b. Furthermore, it is to be understood that the PCIe TX interface 218 may be any applicable interface port interface. For example, the PCIe TX interface 218 may be a dual port or a multi-port interface. Furthermore, RC PCIe interface 204 is coupled to the EP PCIe interface 212 of the first SSD 1 210a via a first bus 224. The high speed bus 226 may have a faster data transfer speed than the low speed bus 230. It is to be understood that the term “bus” may refer to a data path that data may be transferred via.

In the storage system 200, the high speed bus 226 may be utilized for streaming data, commands, and SSD statuses between SSDs from an upstream source to a downstream source. The high speed bus 226 may be a unidirectional data path, in which a data transfer direction of the high speed bus 226 may be static, or a bidirectional data path, in which a data transfer direction of the high speed bus 226 is governed using an in band (PCIe) control message or by using sideband interfaces such as the low speed bus 230 or the SMB bus 228. It is to be understood that the bidirectional data path may be referred to as a half-duplex data channel herein. For example, data may be transferred from a downstream EP PCIe interface 212 to an upstream PCIe TX interface 218 or from an upstream PCIe TX interface 218 to a downstream EP PCIe interface 212 based on the data transfer direction of the high speed bus 226.

Because the storage system 200 needs a bidirectional control path in order to expose data storage device statuses, program statuses, moderate data rate according to the slowest SSD (e.g., programming speed) in the daisy-chain, propagate uplink data transfer retires in case of program failures, and the like, back channel capabilities is required. In the storage system 200, the SMB bus 228 and the low speed bus 230 may be used as a back channel to transfer data, statuses, failure messages, and the like from a downstream SSD to an upstream SSD. In some cases, where the PCIe TX interface 218 is a dual port or multi-port interface, one or more, but less than all, of the ports may be used as an uplink interface and a remaining number of the ports may be used as a downlink interface. Thus, data and commands may be propagated downstream using the uplink interface and data, commands, control data may be communicated back to upstream devices using the downlink interface.

In the storage system 200, the plurality of SSDs 210a-210n may support concurrent programming of the same data propagated through each of the SSDs. For example, when the host device 202 sends data to be programmed to the first SSD 1 210a, the first SSD 1 210a may begin to program the data to its own memory device, such as the NVM 110 of FIG. 1, and generate a write command for each of the other SSDs of the plurality of SSDs 210a-210n. The first SSD 2 210a may generate ECC for the data being programmed to its own memory device. After a predetermined amount of data has been programmed to the first SSD 1 210a, the first SSD 1 210a sends the data and the command via the high speed bus 226 to the second SSD 2 210b. The second SSD 2 210b begins to program the data to its own memory device (e.g., NVM 110 of FIG. 1). The second SSD 2 210b may generate ECC for the data being programmed to its own memory device, where the generated ECC may be the same or different than the generated ECC for the first SSD 1 210a. When a predetermined amount of data has been programmed to the second SSD 2 210b, the second SSD 1 210a sends the data and the command via the high speed bus 226 to the second SSD 2 210b.

Thus, the data sent by the host device 202 is propagated through and stored in each of the plurality of SSDs 210a-210n. It is to be understood that the predetermined amount of data may be a percentage of data that has been programmed to the memory device. For example, the percentage of data that has been programmed to the memory device out of a total amount of data in the data package may be between about 5% to about 50%, where “about” may refer to a range of plus or minus 5%. In some examples, the predetermined amount of data may be set based on SSD requirements in the daisy-chain, such that the predetermined amount of data may be the same for one SSD as another SSD or different for one SSD as another SSD.

During operation of each of the plurality of SSDs 210a-210n, each SSD may perform its own data management operations, such as garbage collection, read verify, wear leveling, and the like. When an SSD determines that data in its memory device is corrupted, the SSD may request data, or in some examples, ECC, from either an upstream SSD or a downstream SSD. For example, if the second SSD 2 210b has corrupted data, the second SSD 2 210b may send a request through either the UART TX 220 of the second SSD 2 210b or the SMB 214 of the second SSD 2 210b to the first SSD 1 210a for the relevant data or from the SMB 214 of the second SSD 2 210b or the high speed bus 226 to an adjacent downstream SSD (e.g., a third SSD 3). Thus, data integrity may be preserved due to multiple copies of the same data being stored in multiple SSDs.

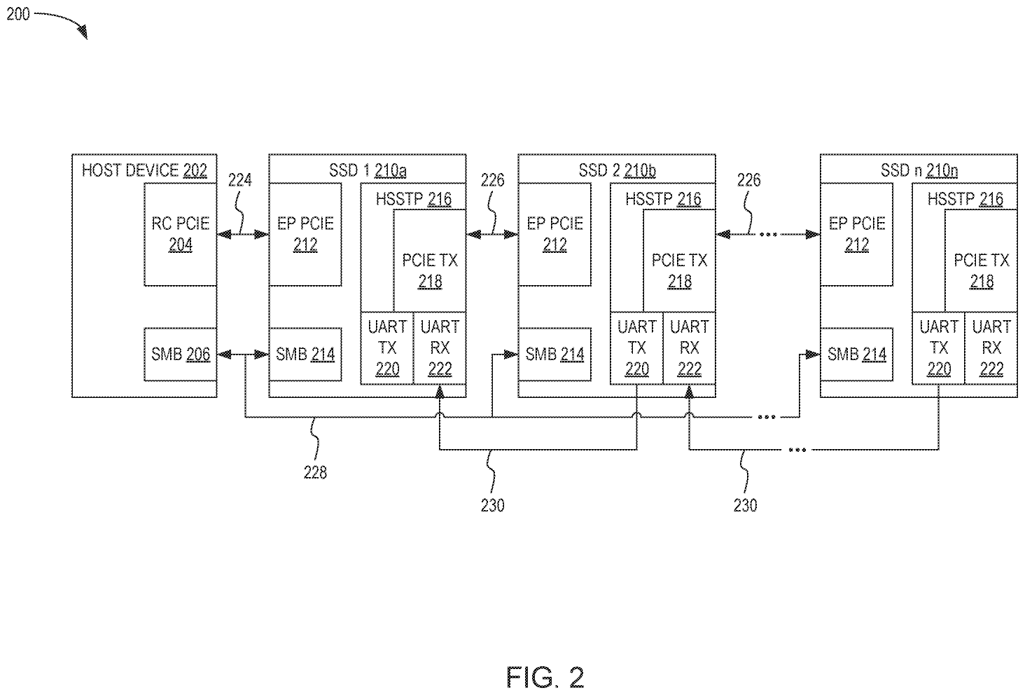

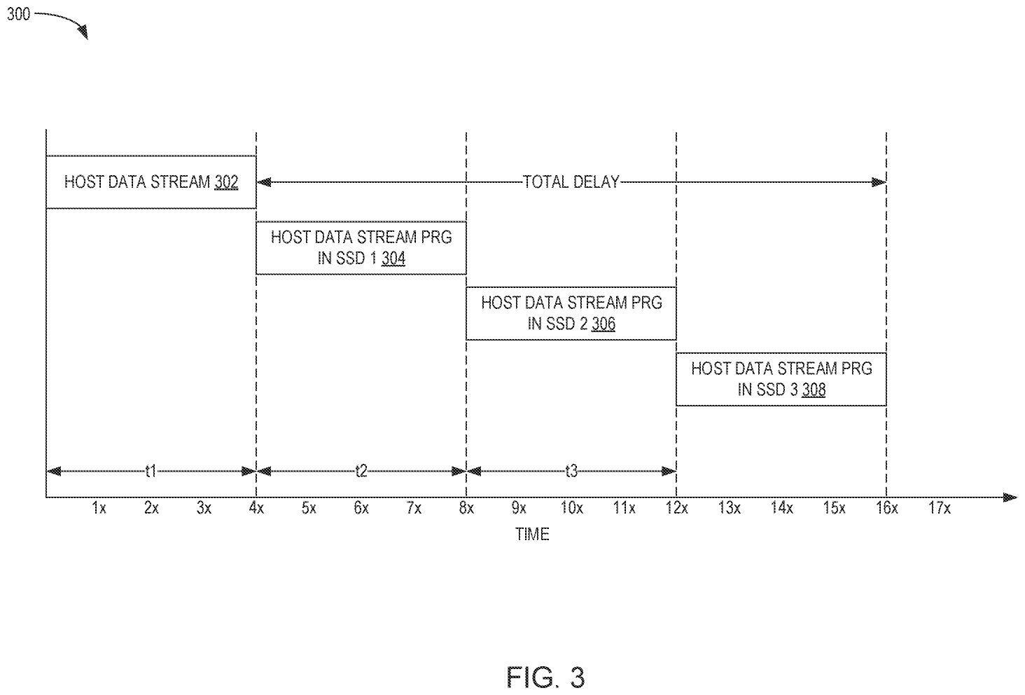

FIG. 3 is an exemplary graph 300 illustrating a time to serially program data to a plurality of data storage devices, such as the plurality of SSDs 210a-210n of FIG. 2, according to certain embodiments. Exemplary graph 300 shows a total time to program data to three SSDs serially. In other words, data is only programmed to a next SSD after the data has been programmed to the current SSD. As shown in FIG. 3, transferring the host data stream 302 to SSD 1 takes a time increment of 4×. Programming the host data stream to SSD 1 304 takes another time increment of 4×. Programming the host data stream to SSD 2 306 takes another time increment of 4×. Programming the host data stream to SSD 1 308 takes another time increment of 4×. Thus, the total delay between when SSD 1 first receives the data from the host device to when the data is fully programmed to all of the SSDs is a time increment of 12×. The time increments shown and referred to are not intended to be limiting, but to provide an example of a possible embodiment.

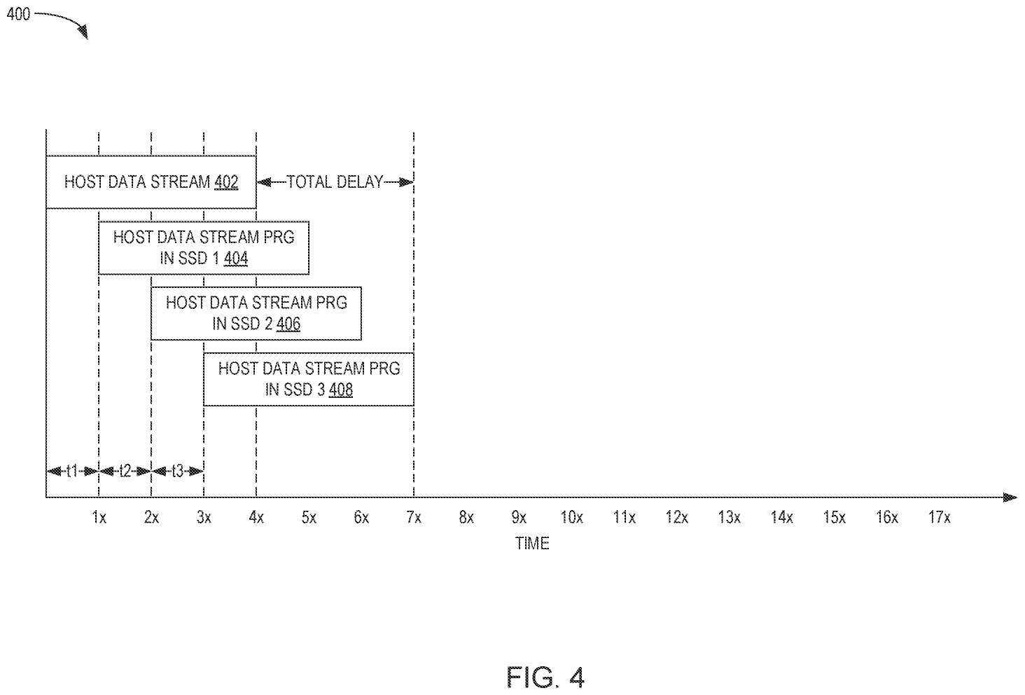

FIG. 4 is an exemplary graph 400 illustrating a time to program data in parallel to a plurality of data storage devices, such as the plurality of SSDs 210a-210n of FIG. 2, according to certain embodiments. For simplification purposes, the time increments shown on the exemplary graph 400 are the same as the time increments shown on the exemplary graph 300 of FIG. 3. The exemplary graph 400 may illustrate a storage system, such as the storage system 200 of FIG. 2, where data sent via a high speed bus, such as the high speed bus 226, to an adjacent downstream SSD in the storage system after a predetermined amount of data has been programmed to the current SSD. Because data is being sent and programmed to each of the SSDs before a previous SSD is finished with programming the data to its own memory device, the programming of data to each of the SSDs may be partially concurrent or in parallel. For example, as shown in the exemplary graph 400, programming data to SSD 1, SSD 2, and SSD3 occurs in parallel. Transferring the host data stream 402 to SSD 1 takes a time increment of 4×. Programming the host data stream to SSD 1 404 takes another time increment of 4×. Programming the host data stream to SSD 2 406 takes another time increment of 4×. Programming the host data stream to SSD 1 408 takes another time increment of 4×. However, programming data to each of the SSDs occurs before data is fully transferred or programmed from a previous source. Thus, a total delay is decreased from a time increment of 16× to a time increment of 3×. The time increments shown and referred to are not intended to be limiting, but to provide an example of a possible embodiment.

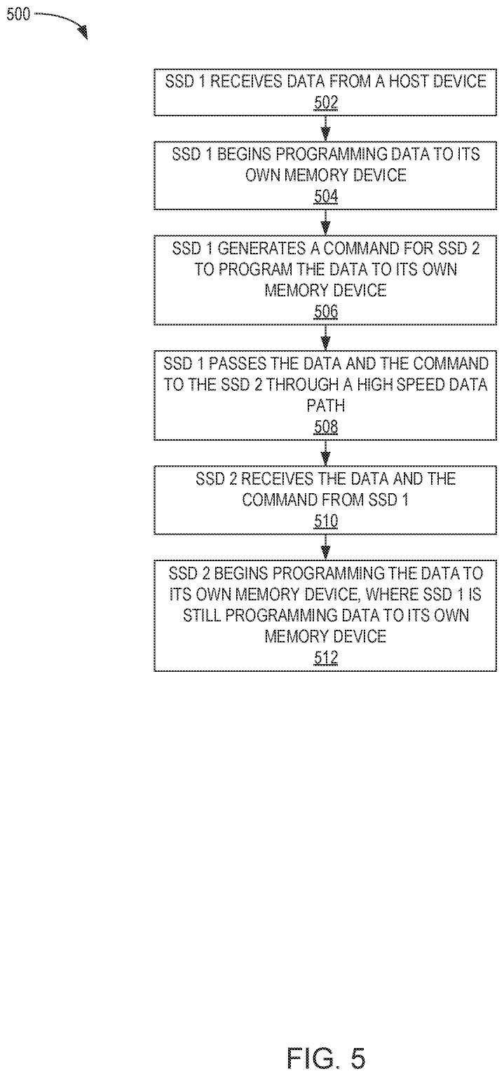

FIG. 5 is a flow diagram illustrating a method 500 of broadcasting data to a plurality of data storage devices, such as the plurality of SSDs 210a-210n of FIG. 2, in a storage system in which the plurality of data storage devices are daisy-chained together, according to certain embodiments. Method 500 may be performed by a storage system, such as the storage system 200 of FIG. 2, where the host device 202 or the first SSD 210a acts as a primary device. For exemplary purposes, aspects of the storage system 200 of FIG. 2 maybe referenced herein.

At block 502, the first SSD 1 210a receives data from the host device 202. At block 504, the first SSD 1 210a begins programming the received data its own memory device (e.g., the NVM 110 of FIG. 1). At block 506, the first SSD 1 210a generates a command for the second SSD 2 210b (and any other SSDs in the storage system) to program the data to the memory device of the second SSD 2 210b. At block 508, the first SSD 1 210a passes the data and the command to the second SSD 2 210b through a high speed data path (e.g., the high speed bus 226). The passing of the data and the command may be responsive to a minimum amount of data (e.g., the predetermined amount of data) from the total data package received from the host device 202 being programmed to the first SSD 1 210a. At block 510, the second SSD 2 210b receives the data and the command from the first SSD 1 210a. At block 512, the second SSD 2 210b begins programming the data to its own memory device (e.g., the NVM 110 of FIG. 1), where programming the data to the second SSD 2 210b occurs concurrently or in parallel with programming data to the first SSD 1 210a.

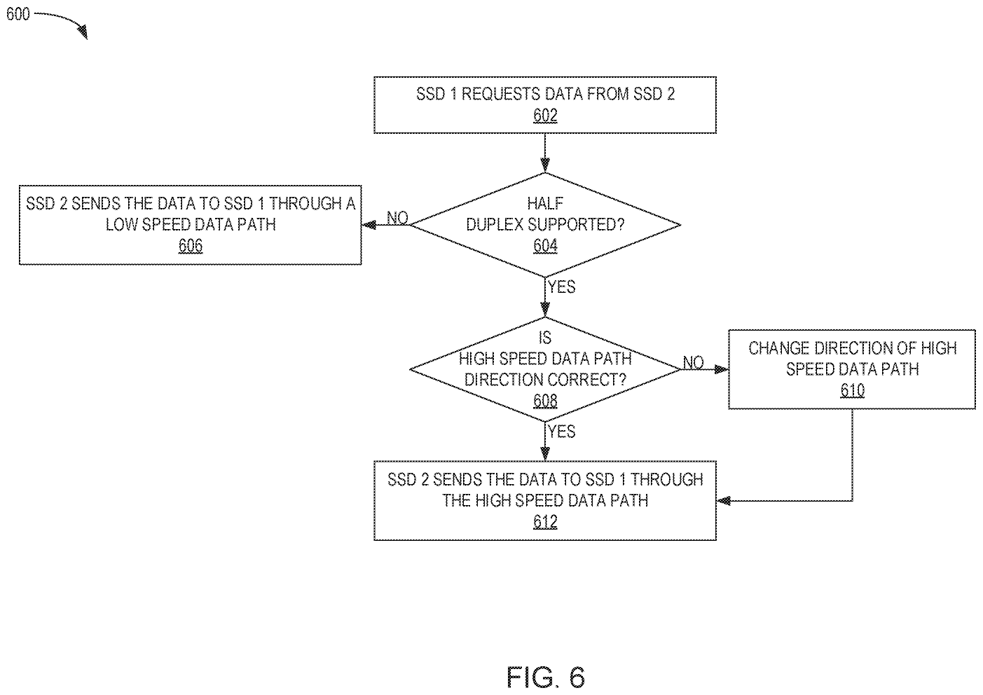

FIG. 6 is a flow diagram illustrating a method 600 of reading data from a data storage device of a plurality of data storage devices, such as the plurality of SSDs 210a-210n of FIG. 2, in a storage system in which the plurality of data storage devices are daisy-chained together, according to certain embodiments. Method 600 may be performed by a storage system, such as the storage system 200 of FIG. 2, where the host device 202 or the first SSD 210a acts as a primary device. For exemplary purposes, aspects of the storage system 200 of FIG. 2 maybe referenced herein.

At block 602, the first SSD 1 210a requests data from the second SSD 2 210b. For example, requesting data may be responsive to the first SSD 1 210a determining that the corresponding data in its own memory device (e.g., the NVM 110 of FIG. 1) has been corrupted. At block 604, the second SSD 1 210b determines if a half-duplex data channel is supported by the high speed bus 226. If the half-duplex data channel is not supported by the high speed bus 226 at block 604, then the second SSD 2 210b sends the data to the first SSD 1 210a though a low speed data path (e.g., the SMB bus 228 or the low speed bus 230) at block 606. However, if the half-duplex data channel is supported at block 604, the second SSD 2 210b determines if the high speed data path transfer direction is correct (i.e., in the right transfer direction) at block 608. If the high speed data path transfer direction is not correct at block 608, the second SSD 210b sends a command through either an in band control message or a sideband control message to change the transfer direction of the high speed data transfer path at block 610. If the high speed data path transfer direction is correct at block 608 or once the direction of the high speed data path has been changed to the correct direction at block 610, then the second SSD 2 210b sends the requested data to the first SSD 1 through the high speed bus 226 at block 612.

By utilizing a high speed data path to broadcast data to a plurality of data storage devices, overall time needed to broadcast and program data to the plurality of data storage devices may be decreased and overall storage system performance may be improved.

In one embodiment, a storage system includes a plurality of data storage devices. Each data storage device of the plurality of data storage devices is coupled to another data storage device of the plurality of data storage devices. Each data storage device includes an end point (EP) PCIe interface, a serial bus (SMB), and a high speed serial trace port (HSSTP) interface. The HSSTP interface includes a PCIe transmitter (TX), a universal asynchronous receiver-transmitter (UART) receiver (RX), and a UART TX. A first data storage device is configured to send data via the PCIe TX of the first data storage device to the EP PCIe interface of a second data storage device. The first data storage device is coupled to the second data storage device. The sending occurs after a predetermined amount of data that is less than all of the data has been programmed to the first data storage device.

Sending data via the PCIe TX of the first data storage device to the EP PCIe interface of the second data storage device occurs over a high speed data path. The high speed data path is unidirectional. The high speed data path is a TX path. The high speed data path is dual-directional. The high speed data path is configured to switch from a TX path to an RX path and from the RX path to the TX path. A control message controlling the switching is communicated through the high speed data path. A control message controlling the switching is communicated over the UART RX and the UART TX of adjacent data storage devices. The switching a control message controlling the switching is communicated over the SMB of adjacent data storage devices. The second data storage device is configured to send data back to the first data storage device via a low speed data path coupling the UART TX of the second data storage device to the UART RX of the first data storage device. The low speed data path has a slower data transfer speed than the high speed data path. The first data storage device is coupled to a host device. The first data storage device is further configured to receive the data from the host device via a data path coupling a root complex (RC) PCIe interface of the host device to the EP PCIe interface of the first data storage device and cause the data to be transferred to each of the other data storage devices of the plurality of the data storage devices to be programmed. The data is programmed to two or more data storage devices of the plurality of data storage devices concurrently. The first data storage device is further coupled to at least another data storage device other than the second data storage device. Each data storage device of the plurality of data storage devices are configured to communicate with each other data storage device of the plurality of data storage devices via the SMB. At least one data storage device of the plurality of data storage devices comprises a second EP PCIe interface.

In another embodiment, a storage system includes a first data storage device and a second data storage device coupled to the first data storage device. The first data storage device is configured to program data to a non-volatile memory (NVM) device of the first data storage device, generate a write command for the second data storage device to program the data to an NVM device of the second data storage device, and send the data to the second data storage device via a high speed data path coupling the first data storage device to the second data storage device after a predetermined amount of the data has been programmed to the NVM device of the first data storage device. The high speed data path is distinct from a low speed data path. The low speed data path has a data transfer speed less than the high speed data path. The high speed data path is utilized to transfer write data. The low speed data path is utilized to transfer read data. The second data storage device is configured to receive the data from the first data storage device and program the data to the NVM device of the second data storage device. Programming the data to the NVM device of the second data storage device occurs partially concurrently with programming the data to the NVM device of the first data storage device.

First error correction code (ECC) is generated by the first data storage device for the data programmed to the NVM device of the first data storage device and programmed and to the NVM device of the first data storage device. Second ECC is generated by the second data storage device for the data programmed to the NVM device of the second data storage device and programmed and to the NVM device of the second data storage device. The second data storage device is configured to request the first ECC from the first data storage device to correct the data programmed to the NVM device of the second data storage device. The first data storage device is configured to request the data programmed to the NVM device of the second data storage device responsive to determining that the data programmed to the NVM of the first data storage device is corrupted. The low speed data path is further utilized to transfer control data.

In another embodiment, a storage system includes a first data storage device, a second data storage device coupled to the first data storage device, means for transferring write data from the first data storage device to the second data storage device, and means for transferring read data and control data between the first data storage device and the second data storage device. The means for transferring write data is distinct from the means for transferring read data and control data.

The first data storage device is configured to receive data from a host device to program to a memory device of the first data storage device, program the data to the memory device of the first data storage device, generate a command for the second data storage device to program the data to a memory device of the second data storage device, and send the data and the generated command to the second data storage device. The second data storage device is configured to program the data to the memory device of the second data storage device. Programming the data to the memory device of the second data storage device occurs partially concurrently to programming the data to the memory device of the first data storage device.

While the foregoing is directed to embodiments of the present disclosure, other and further embodiments of the disclosure may be devised without departing from the basic scope thereof, and the scope thereof is determined by the claims that follow.

What is claimed is:

1. A storage system, comprising:
a plurality of data storage devices, wherein:
each data storage device of the plurality of data storage devices is coupled to another data storage device of the plurality of data storage devices;
each data storage device comprises:
an end point (EP) peripheral component interconnect (PCI) express (PCIe) interface;
a serial bus (SMB); and
a high speed serial trace port (HSSTP) interface, wherein the HSSTP interface comprises:
a PCIe transmitter (TX);
a universal asynchronous receiver-transmitter (UART) receiver (RX); and
a UART TX; and
a first data storage device is configured to send data via the PCIe TX of the first data storage device to the EP PCIe interface of a second data storage device, wherein:
the first data storage device is coupled to the second data storage device; and
the sending occurs after a predetermined amount of data that is less than all of the data has been programmed to the first data storage device.

2. The storage system of claim 1, wherein sending data via the PCIe TX of the first data storage device to the EP PCIe interface of the second data storage device occurs over a high speed data path.

3. The storage system of claim 2, wherein the high speed data path is unidirectional, and wherein the high speed data path is a TX path.

4. The storage system of claim 2, wherein the high speed data path is dual-directional, wherein the high speed data path is configured to switch from a TX path to an RX path and from the RX path to the TX path.

5. The storage system of claim 4, wherein a control message controlling the switching is communicated through the high speed data path.

6. The storage system of claim 4, wherein a control message controlling the switching is communicated over the UART RX and the UART TX of adjacent data storage devices.

7. The storage system of claim 4, wherein the switching a control message controlling the switching is communicated over the SMB of adjacent data storage devices.

8. The storage system of claim 2, wherein the second data storage device is configured to send data back to the first data storage device via a low speed data path coupling the UART TX of the second data storage device to the UART RX of the first data storage device, and wherein the low speed data path has a slower data transfer speed than the high speed data path.

9. The storage system of claim 1, wherein the first data storage device is coupled to a host device, and wherein the first data storage device is further configured to:
receive the data from the host device via a data path coupling a root complex (RC) PCIe interface of the host device to the EP PCIe interface of the first data storage device; and
cause the data to be transferred to each of the other data storage devices of the plurality of the data storage devices to be programmed.

10. The storage system of claim 1, wherein the data is programmed to two or more data storage devices of the plurality of data storage devices concurrently.

11. The storage system of claim 1, wherein the first data storage device is further coupled to at least another data storage device other than the second data storage device.

12. The storage system of claim 1, wherein each data storage device of the plurality of data storage devices are configured to communicate with each other data storage device of the plurality of data storage devices via the SMB.

13. The storage system of claim 1, wherein at least one data storage device of the plurality of data storage devices comprises a second EP PCIe interface.

14. A storage system, comprising:
a first data storage device; and
a second data storage device coupled to the first data storage device, wherein the first data storage device is configured to:
program data to a non-volatile memory (NVM) device of the first data storage device;
generate a write command for the second data storage device to program the data to an NVM device of the second data storage device; and
send the data to the second data storage device via a high speed data path coupling the first data storage device to the second data storage device after a predetermined amount of the data has been programmed to the NVM device of the first data storage device, wherein:
the high speed data path is distinct from a low speed data path;
the low speed data path has a data transfer speed less than the high speed data path;
the high speed data path is utilized to transfer write data; and
the low speed data path is utilized to transfer read data; and
wherein the second data storage device is configured to:
receive the data from the first data storage device; and
program the data to the NVM device of the second data storage device, wherein programming the data to the NVM device of the second data storage device occurs partially concurrently with programming the data to the NVM device of the first data storage device.

15. The storage system of claim 14, wherein:
first error correction code (ECC) is generated by the first data storage device for the data programmed to the NVM device of the first data storage device and programmed and to the NVM device of the first data storage device; and
second ECC is generated by the second data storage device for the data programmed to the NVM device of the second data storage device and programmed and to the NVM device of the second data storage device.

16. The storage system of claim 15, wherein the second data storage device is configured to request the first ECC from the first data storage device to correct the data programmed to the NVM device of the second data storage device.

17. The storage system of claim 15, wherein the first data storage device is configured to request the data programmed to the NVM device of the second data storage device responsive to determining that the data programmed to the NVM of the first data storage device is corrupted.

18. The storage system of claim 14, wherein the low speed data path is further utilized to transfer control data.

19. A storage system, comprising:
a first data storage device;
a second data storage device coupled to the first data storage device;
means for transferring write data from the first data storage device to the second data storage device; and
means for transferring read data and control data between the first data storage device and the second data storage device, wherein the means for transferring write data is distinct from the means for transferring read data and control data.

20. The storage system of claim 19, wherein:
the first data storage device is configured to:
receive data from a host device to program to a memory device of the first data storage device;
program the data to the memory device of the first data storage device;
generate a command for the second data storage device to program the data to a memory device of the second data storage device; and
send the data and the generated command to the second data storage device; and
the second data storage device is configured to:
program the data to the memory device of the second data storage device, wherein programming the data to the memory device of the second data storage device occurs partially concurrently to programming the data to the memory device of the first data storage device.
